(19) United States
(12) Patent Application Publication
(10) Pub. No.: US 2022/0374814 A1
(43) Pub. Date: Nov. 24, 2022

(54) RESOURCE CONFIGURATION AND MANAGEMENT SYSTEM FOR DIGITAL WORKERS

(71) Applicant: Ampliforce Inc., Boston, MA (US)

(72) Inventor: Marco Buchbinder, Weston, MA (US)

(73) Assignee: Ampliforce Inc., Boston, MA (US)

(21) Appl. No.: 17/731,101

(22) Filed: Apr. 27, 2022

Related U.S. Application Data
(60) Provisional application No. 63/181,856, filed on Apr. 29, 2021.

(51) Int. Cl. G06Q 10/06

(52) U.S. Cl. CPC G06Q 10/063112

(57) ABSTRACT

A resource configuration and project management system identifies sandboxed task data and task parameters including project skill sets and project tools. An online community is provided of autonomous or semiautonomous artificial agents (digital workers), examples being chatbots for customer service, technical support, and advisory services. The digital workers are matched to projects based on skills and past performance metrics. Digital workers may be trained (using well-known supervised, unsupervised, or semi-supervised approaches) for specific tasks, such as parsing, analysis, filling, and/or characterization of particular types of digital document.

### BACKGROUND

Implementation of Artificial Intelligence (AI)/Machine Learning is becoming a critical component in many business infrastructures for data handling and analytics. Unfortunately, the adoption of many of these algorithms has been slowed in the enterprise world due to several challenges. Some of these challenges may be due to the current open source AI software lacking enterprise level security, testing, and support.

Another challenge may be due to the massive amounts of data that are needed to train and feed AI algorithms since data is typically “dirty”, unaligned and hard to source and collect. Another impediment for adoption is due to the scarcity of skilled AI digital workers which are expensive and hard to retain on different AI systems. Therefore, a need exists for improving adoption of AI/Machine Learning algorithms in an enterprise environment.

U.S. Pat. No. 10/817,813, titled “Resource Configuration and Management System”, describes a system that manages resources, including developers. It is desirable to extend such a system to meet a long felt need for improved recommendation and selection of digital workers, i.e., “bots”, and for the automatic configuration of, training of, and learning by digital workers for use in tasks and projects.

### BRIEF SUMMARY

A method of operating a resource configuration and project management system involves identifying, for a project, sandboxed task data and task parameters comprising project skill sets and project tools. The method configures a first selector with the project skill sets to select at least one digital worker from a digital worker pool. The method configures a second selector with the project tools to select at least one container comprising at least one set of programming functions from a container library. The method assigns the selected at least one digital worker to a working task queue generated from the task parameters. The method may configure the selected at least one container to operate as a sandboxed environment with the sandboxed task data. The method authorizes the selected at least one digital worker to access the selected at least one container and the sandboxed task data within the sandboxed environment through operation of an authorization service. The method monitors sandboxed environment digital worker resources and sandboxed environment computing resources during execution of the project by the selected at least one digital worker through operation of a monitoring service.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a system 100 in accordance with one embodiment.

FIG. 2 depicts a user interface 102 in accordance with one embodiment.

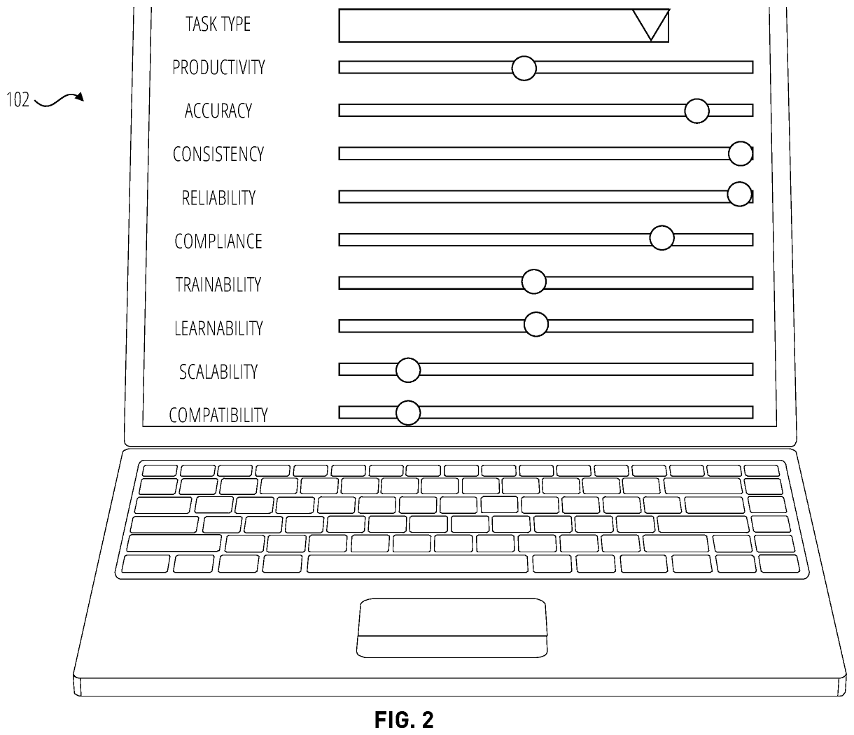

FIG. 3 depicts a method 300 in accordance with one embodiment.

FIG. 4 depicts a system 400 in accordance with one embodiment.

FIG. 5 depicts a method 500 in accordance with one embodiment.

FIG. 6 depicts a system 600 in accordance with one embodiment.

FIG. 7 depicts a system 700 in accordance with one embodiment.

FIG. 8 depicts a basic deep neural network 800 in accordance with one embodiment.

FIG. 9 depicts an artificial neuron 900 in accordance with one embodiment.

FIG. 10 depicts an OS container 1000 in accordance with one embodiment.

FIG. 11 depicts a high-level architecture 1100 in accordance with one embodiment.

FIG. 12 depicts a platform architecture 1200 in accordance with one embodiment.

FIG. 13 depicts a workflow 1300 in accordance with one embodiment.

FIG. 14 depicts an illustrative computer system architecture that may be used in accordance with one or more illustrative aspects described herein.

### DETAILED DESCRIPTION

“Container” refers to a class or a data structure whose instances are collections of other objects. In other words, they store objects in an organized way that follows specific access rules.

“Digital worker pool” refers to a group of digital workers.

“Digital workers” are autonomous and semi-autonomous (human supervised) machine agents utilizing artificial intelligence.

“Sandboxed environment ” refers to a testing environment that isolates untested code changes and experimentation from the production environment or repository.

“Working task queue ” refers to a set of tasks that are scheduled to be performed or are in progress.

The disclosure is generally directed to a method of operating a resource configuration and project management system, which involves identifying, for a project, sandboxed task data and task parameters including project skill sets and project tools. The system improves the execution efficiency over prior systems in a number of ways, for example removing/reducing the system bottleneck created by supervised learning of digital workers in conventional systems. Concurrently with reducing this bottleneck, the system enables further technical efficiency by removal/reduction of branch or decision points that occur in conventional systems for selection and clustering of digital workers. The system may be operationally more robust than conventional systems due to having a reduced (or eliminated) number of branch points (or decision points). The reduced branching (or decision) complexity may improve system performance and/or reliability, and may reduce the possibility of the system becoming unstable. Further, by containerizing computing functions for controlled access across and by digital workers in a pool or collaborative cluster, the system may reduce memory consumption compared to conventional systems, by re-allocation of processing functions and re-allocation of data storage. In conventional systems digital workers may often comprise self-encapsulated algorithms and functions. A re-allocation of these functions to sandboxed containers may be more efficient due to enabling lower latency to access data by certain components, less frequent or smaller data communication between components, and lower data storage requirements due to code sharing. A re-allocation of task data and code to containers may be more efficient due to enabling higher utilization of underutilized components, reduced inter-digital-worker communication, and reduced execution complexity, for example.

An online community is provided for digital workers, data scientists, students (members), and human developers (e.g., software engineers). Digital workers are autonomous or semiautonomous artificial agents, well-known examples being chatbots for customer service, technical support, and advisory services. Digital workers may be trained (using well-known supervised, unsupervised, or semi-supervised approaches) for specific tasks, such as parsing, analysis, filling, and/or characterization of particular types of digital document. In one example, digital workers in the online community may be trained to parse, analyze, fill out, and/or characterize or provide advisory services for asset title documents.

Each human or digital worker in the community may:
Have an associated profile of attributes, skills, and experience.
Access digital content from the community blogs, news, white papers, videos, and the like.
Post such content to the community.
Communicate with other members via a private or group mechanism such as chat, Slack, and the like.
Form project teams comprising other members (human and digital workers) and data sets.
Participate in competitions to evaluation and characterize their skill sets.
Apply for jobs.
Share their expertise on specific topics.
Become certified for specific skill sets.

The system tracks and measures a member's relative capabilities to perform tasks, based on criteria segmented in a number of categories (project experience, certifications, test performance, engagement within the platform, performance in competitions, customer reviews, accuracy of answers, etc.). The thousands of data-points generated from each member's activities are tracked and registered within a database, and each data-point is assigned a numerical value. These values are applied as inputs to algorithms to ultimately generate a dynamically calculated score (Q-Score) for suitability of persons or digital agents to specific tasks.

In one embodiment the score is calculated by assigning weights to outcomes in a (e.g., additive) formula. The higher the importance of the activity, the higher value is the weight for that activity. For example, in order of descending weight magnitude:
Number of jobs completed with high satisfaction review
Number of jobs completed
Number of certifications
Number of tests passed
Number of competitions won
Number of competitions joined
Number of followers
Number of unique viewers of content (e.g., blog posts) posted
Number of content items posted
Number of content items viewed/read

Unsupervised learning techniques may then be applied to these weighted metrics, which may be formed into tensors for a trained classifier (e.g., neural network, random forest, or Support Vector Machine classifier), to identify clusters of similar and/or complementary community members. Community members in the same cluster may be encouraged or identified to connect and collaborate on specific projects, based on specifications (skills needed, costs) of those projects. Clusters containing a high number of members with high value of Q-Score may also be used to assign an expected Q-Score to new members that are in the same cluster.

Supervised learning techniques require labelled data to train a model. If client satisfaction on previously attempted projects is used as the label, supervised learning may be utilized to train a model that will attempt to predict client satisfaction for a community member on a particular project or skill-based activity, based on past activity of the member. Members should therefore be encouraged to be as active as possible in the community because each activity they successfully complete will go toward generating a higher Q-Score, thus making them more attractive to employers.

Machine learning models may be applied to generate an applicant match score that matches jobs posted by an employer to the likelihood of success of community members (people and digital assistants) for that job based on 1) key meta-data related to the past profile (Q-Scores for particular skills and tasks) and current engagement of the members, 2) apply natural language processing (NLP) to extract key requirements from job descriptions posted by employers on the community, and 3) using supervised learning methods to draw correlations between data from #1, #2 to generate an job/member match score.

In one embodiment, meta-data collected for the generation of the applicant match score includes profile data (years of work experience, knowledge of programming languages, experience with AI development frameworks, previous employers, previous education, previous certifications, number of jobs completed, rating received on previous jobs); and digital engagement data (posts made, recommendations received, number of upvotes received on posts, hackathon participation, certifications taken, certification scores, number of followers, contribution made to community in terms of number of assets published (i.e. models, API's, machine learning pipelines, etc.).

Metrics utilized for generation of the Q-Score for digital workers may also include some or all of those in Table 1.

TABLE 1

| DW Attribute | Metric to Measure | Example |
|---|---|---|
| Task type | Classification of task | Repetitive Process - Documents; |
| executed by | | Repetitive Process - Non Documents; |
| digital | | Others (e.g. Data, Voice, Code generation) |
| worker | | |
| Productivity | Turn-around time | Time taken to process a single |
| | | document of a specific type and |
| | | complexity - extraction through |
| | | validation |
| Accuracy | Error rate, precision, | Document identification and |
| | percent specifications met | classification accuracy |
| Consistency | Repeatability of outcomes | Percent of times the errors in |
| | with expected accuracy | translating documents exceeded |
| | Sigma (3 s-6 s) | acceptable limits (e.g., wrong fields |
| | | and wrong values of fields translated |
| | | in given time-period per document) |
| Reliability | Fault tolerance, digital | Percent of time digital worker was |
| | worker availability | available for tasks, e.g., 99.99% |
| Compliance | Ability to meet regulatory | As per required statutes, |
| | compliance, data Privacy | rules, and regulations. |
| | (GDPR and others) | |
| | Incidences of non-compliance | |
| Trainability | Ability and learning rate to learn | Capability and training time to |
| | to identify and process tasks. | process documents (e.g., Invoices, |
| | Ability and learning rate to learn | Title Documents) or forms of a |
| | to generate alerts for exception | various types, structure, format, or |
| | and error conditions. | language. |
| Learnability | Improvement in accuracy and | Percent improvement in accuracy in a |
| | productivity with learning | set time interval to improve |
| | (supervised or unsupervised) | translating documents to output |
| | | format - faster learning is better |
| Scalability | Performance with increasing | At what volume of documents does |
| | volume and/or complexity | the accuracy, productivity, and/or |
| | | consistency fall below permissible |
| | | limits. |
| Compatibility | Ease of Integration to/with | Time and effort to deploy in target |
| | existing systems, including | environment. |
| | other digital workers. | Number of errors during integration |
| | | and during initial runs. Interventions |
| | | required |

The project management aspects of the system enable diverse cross functional teams to work together such a data scientists, business, mathematicians, physicists, full-stack developers and traditional IT roles. It provides support for multiple project management methodologies, such as Agile, Kanban, Scrum, and variants of these. Collaborative white-boarding may also be enabled between the cross-functional teams. Specific roles may be assigned such as full time, short duration, come-in-and-out, advisor, contributor, and reviewer.

The system may provide RACI and deliverables between team, integration with enterprise collaboration COTS or in-house communication and collaboration tools, co-development of code, access to diverse data sources, ability to trace context, remove biases, discard and use fresh data sets, drill down to the task or sub-task level, rapid resource allocation and RACI between in-house and external teams, workflow automation, and user stories, scenarios, and use cases.

The project management aspects of the system may also support scheduling, task allocation, code reviews, code versioning, CICD, requirement capture & requirement base-line, requirements tracking, traceability, multiple user profiles, issue and bug tracking, Gantt charts, resource allocation, API integration and API connections.

In one embodiment the system configures a first selector with the project skill sets to select at least one digital worker from a digital worker pool. The system also configures a second selector with the project tools to select at least one container comprising at least one set of programming functions from a container library. Next, the system assigns the selected at least digital worker to a working task queue generated from the task parameters. The selected at least one container may be configured to operate as a sandboxed environment with the sandboxed task data.

The selected at least one digital worker may be authorized to access the selected at least one container and the sandboxed task data within the sandboxed environment through operation of an authorization service. The method also monitors sandboxed environment digital worker resources and sandboxed environment computing resources during execution of the project by the selected at least one digital worker through operation of a monitoring service.

In some configurations, the monitoring service may include a digital worker activity tracker, a resource utilization tracker, and a project output evaluator. The digital worker activity tracker periodically may collect updates to the task(s) assigned to the digital worker as part of monitoring the sandboxed environment digital worker resources. The resource utilization tracker may monitor the sandboxed environment computing resources of the selected at least one container. The project output evaluator may communicate a payment release control to a payment service in response to detecting a completed project.

In some instances, the method may rank digital workers in the digital worker pool through operation of a rating engine configured by the task parameters and usage logs from the monitoring service, wherein the usage logs comprise the sandboxed environment digital worker resources and the sandboxed environment computing resources collected by the monitoring service. The method may operate the first selector to select the at least one digital worker from a ranked digital worker pool by way of the rating engine. In some configurations, the rating engine may include a correlator for relating the usage logs to corresponding digital workers and a scoring function to generate a digital worker score from the usage logs for the project/task.

In some configurations, the at least one container may be an operating system container comprising at least one functional container comprising the at least one set of programming functions.

In some configurations, the selected at least one digital worker may access the selected at least one container through an API gateway.

In some configurations, the authorization service is configured to allocate computing resources for the selected at least one container through an API gateway.

In some configurations, the sandboxed task data and the task parameters are identified from a development project specification through operation of a parser. In some instances, the development project specification is received through a user interface.

In some configurations, the monitoring service comprises a machine learning algorithm. The machine learning algorithm may generate container recommendations to configure the second selector to select at functional containers to be utilized by the project, wherein the machine learning algorithm utilize the task parameters, previous completed projects, and usage logs to generate the container recommendations. In some configurations, the machine learning algorithm is a deep learning neural network.

In some configurations, the selected at least one digital worker has access to automation and analysis tools for use within the sandboxed environment.

In one embodiment, implementation of a resource configuration and management system may be demonstrated in a service platform. The service platform is a secure, cloud-based, AI-as-a-service platform that delivers immediate and scalable access to the API connected datasets, expert AI talent, collaboration & project management tools, and machine & deep learning algorithms necessary to AI enable applications, business processes and corporate enterprises. The service platform service is a human-assisted AI-as-a-service platform that delivers machine learning and deep learning based solutions and industry focused platform based software applications from a secure cloud-based platform. The service platform leverages advanced open-source AI tools and libraries, platform certified AI digital workers, API connected data and microservices, and integrated collaboration and workflow management tools to deliver customized solutions that improve operational efficiencies and deliver transformative intelligence to users. The service platform is a fully-managed, highly-scalable, secure, cloud-based AI-as-a-service platform designed to automate and simplify the ability of organizations to leverage AI to enhance business processes and gain competitive advantages.

The open source AI software certification process utilities are applicable on many different types of software code. The platform has developed a process to analyze, cleanse and vet open source software. The process automatically analyzes open source AI tools and libraries for rogue, nefarious code and/or malware and viruses. The unique process automatically extracts and compiles the filtered/cleaned software.

Platform talent certification process filters, background checks, and skill tests determine capabilities and apply a mathematical algorithm to derive a platform talent score.

As an example of the platform capabilities, platform bond data extraction extracts key knowledge points using NLP from bond documents. This data may be used to identify credit waterfalls, guarantors, interest rate calculation methods, authorized denominations, bond counsel, bond purpose classes, liquidity facility, DTC eligibility, capital type, bond insurance, call max, compound yield, compound accelerated value, sinking fund redemption frequency, CUSIP, and call price, but is not limited thereto.

As another example of the capabilities, the platform ESG (Environmental, Social, and Governance) score collects environmental, social, and governance data, and applies a proprietary algorithm to calculate an ESG score. The ESG score measures a company's relative ESG performance based on 50 high level criteria segmented in three categories (environmental, social, and governance). The 50 criteria are distilled from thousands of data-points for each company—each data-point is given a numerical value and these values are calculated by applying unique values. These values are then used as inputs in platform algorithms.

In an embodiment, the platform NLP (natural language processing) confidence score is a mathematical methodology to calculate the probability/relative confidence of the accuracy of NLP results extracted from documents. This score is based on leveraging historic/accurate results to train the platform and leverage an algorithm to determine a relative confidence on each answer.

In an embodiment, the platform probability of default score (used in our counterparty risk application) is a unique methodology to compute a firm's expected default frequency (EDF) from items including standard balance sheet line items, stock price, and news, but is not limited thereto. The platform approach is similar to that of Kealhofer, McQuown, and Vasicek (KMV)'s implementation of the Merton (1974) model, however it offers a propriety mapping from firm Distance to Default (DD) to EDF. Instead, and as consistent with Merton, a normal distribution is assumed to transform the computed DD into an EDF.

Under Merton, firm equity (E) is interpreted as a call option of firm value struck against its debt (D). With the platform's methodology, the Black and Scholes (1973) option pricing model is applied. However, in order to correctly apply the Black and Scholes option pricing model, the firm's (unobservable) current value of assets V_0 and volatility of assets 6_V must be specified. The platform has developed a method to estimate these values by simultaneously solving the following system of equations:

With V_0 and σ_V determined, DD is then computed as the Black and Scholes d_2 parameter. The transformation from DD to EDF is then given by N( [symbol] -d [symbol] _2), where N denotes the cumulative standard normal distribution. Using regression testing on historic defaults rates, the platform developed a methodology to apply a mathematic model based on delta change stock price and stock volume over time. The platform may provide a “controversial news score” that offers an accurate and dynamically calculated probability of default score (platform PD Score).

The service platform is a human-assisted AI-as-a-service platform that delivers machine learning and deep learning based solutions and industry focused platform software applications from a secure cloud-based platform. The service platform leverages advanced open-source AI tools and libraries, platform certified AI digital workers, API connected data and microservices, and integrated collaboration and workflow management tools to deliver customized solutions that improve operational efficiencies and deliver transformative intelligence to users. The service platform is a fully-managed, highly-scalable, secure, cloud-based AI-as-a-service platform designed to automate and simplify the ability of organizations to leverage AI to enhance business processes and gain competitive advantages.

The service platform manager is a set of secure web-based management services that provides identity & access management (IAM), cloud resource management, team collaboration, project management, time tracking, source code management, API management and reporting. The service platform manager provides:
Security Administration
User Authentication and Role Based Access Controls
Budget Tracking
API management and Reporting
Project management (includes Jira API integration)
Time tracking
Source code management and version control (includes GitHub API integration)
Team collaboration (includes Slack API Integration)
End-to-end Monitoring & Reporting

The platform API gateway is a component of the service platform manager, the API gateway delivers users the ability to quickly create highly scalable REST APIs that connect resources (data and microservices) using a Serverless framework, Django functions, and Jason Web Tokens (JWT). The platform API gateway is a fully managed service that makes it easy for digital workers to create, publish, maintain, monitor and secure API's at any scale. The cloud infrastructure is built on AWS and the service platform seamlessly integrates Amazon Web Services with the service platform's custom built tools and API connected applications services in order to deliver a secure, fully managed AI-as-a-service platform. The platform's cloud infrastructure services are platform agnostic (i.e., operable on different platforms for example IBM, Microsoft, etc.,) as well as and Premise Agnostic (i.e., deployed on premise or in the cloud). AWS cloud infrastructure services leveraged by the service platform:
EC2 Compute
S3 Storage
Amazon Redshift
ElasticSearch
CloudWatch
CloudFormation
SNS (Simple Notification Service)
SQS (Simple Queue Services)

Platform certified digital workers' portal is a database of platform certified AI digital workers securely linked to the service platform. Search the platform certified digital workers_DB to quickly identify qualified digital workers. Filter by:
Skills
Past Experiences
Education
Language Proficiency
Location
Availability

The platform allows one to invite platform certified digital workers to collaborate on a project, set budgets, limit billable hours per week, and assign tasks. BYOT (Bring-Your-Own-Talent) provides the ability to add existing corporate resources and project managers to the platform certified digital workers_DB. Features allow one to track hours, review code and even access work diaries with screenshots of work progress taken every 10 minutes. (See details on Time-Tracking and Jira, GitHub and Slack API Integrations for additional details)

The platform AI Starter Kits are a software containers with pre-configured, tested, NVD (National Vulnerability Database) scanned machine and deep learning tools and libraries bundled in automatically deployable private docker images. The Starter Kits are designed to streamline the delivery of any AI project. Containers include, but are not limited to Source & Collect, Data Science, Machine Learning, Deep Learning, Translate, OCR, Analyze, Natural Language Processing, Computer Vision, etc.

The data marketplace is a subscription based service that may provide secure API access to many (e.g., thousands of) existing datasets.

The platform service platform may make it easy to create, update and automatically publish datasets that can be linked via API to systems, applications or AI development projects. Other features include searching for available datasets by key work or filter by data type, publisher or update frequency, viewing charts and downloading tables to EXCEL. Existing datasets may be available on a subscription basis.

Datasets may be made available on a subscription basis.

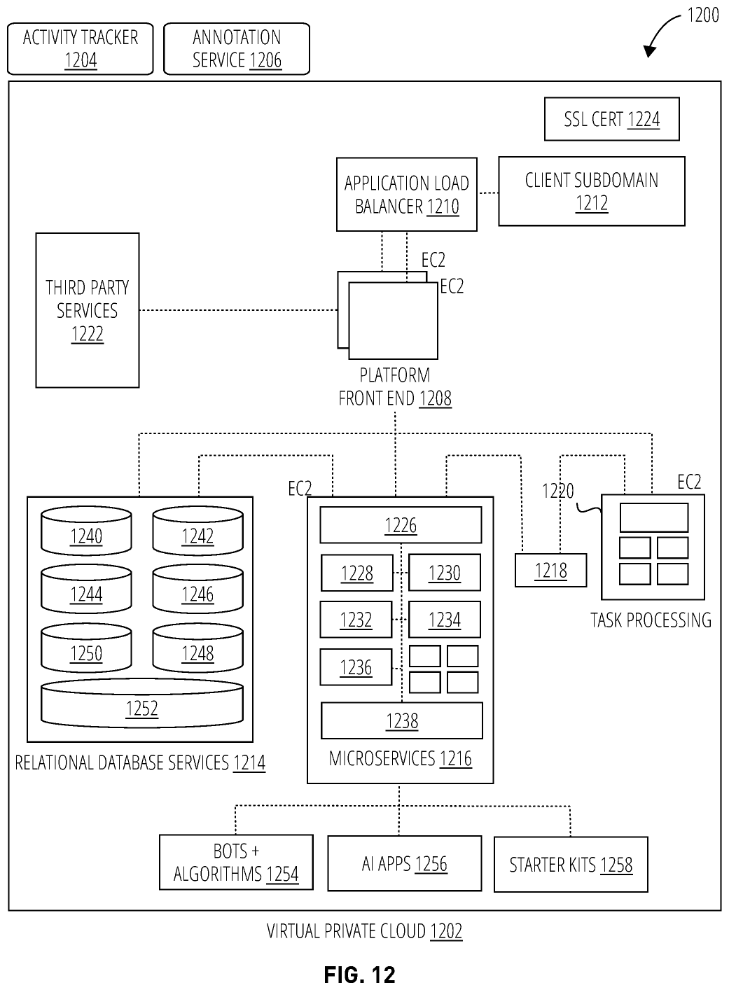

The platform may be operated as a whole, or portions may be operated as standalone microservices, such as the data exchange service described below in FIG. 12.

In one embodiment, the system comprises digital workers configured and trained to receive, read, extract data from, and act on digital documents especially in vertical markets such as medical billing and mortgage processing (e.g., title searching). The system may organize a collection of digital workers to automate or semi-automate such workflows. For example, based on requirements configured by a user of the system, the system may organize a set of digital workers to- read email and other digital documents, extract information from those sources, obtain additional information from online databases, fill or extract fields from online or digital forms, and add records to database to effectuate various resource transfers or exchanges. The system may also recommend particular digital workers to a user based on learning of which perform best at certain tasks at certain price points.

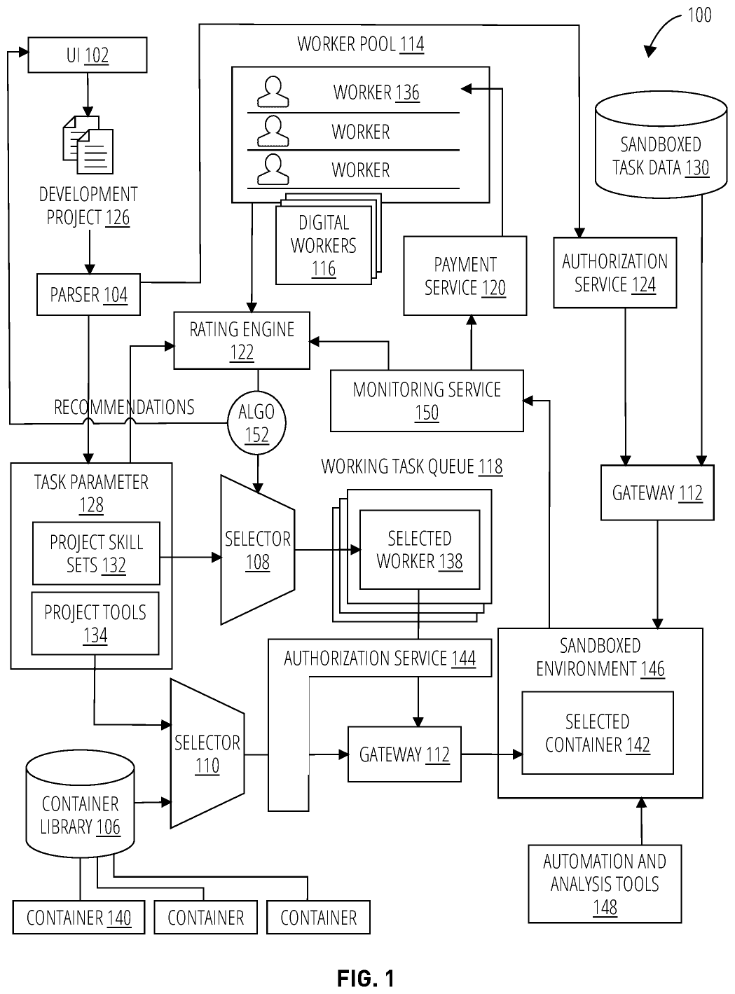

FIG. 1 depicts a system 100 for a resource configuration and project management. The system 100 comprises a user interface 102, a parser 104, a container library 106, a first selector 108, a second selector 110, an API gateway 112, a worker pool 114 including human workers and digital workers 116, a working task queue 118, a payment service 120, a rating engine 122, and an authorization service 124.

In the system 100, a development project specification 126 for a project is received through a user interface 102. The development project specification 126 includes task parameter 128 and identifies sandboxed task data 130 to be utilized in the project. In some configurations, the task parameter 128 and the sandboxed task data 130 are identified through operation of a parser 104 that extracts the details from the development project specification 126. The task parameter 128 comprise project skill sets 132 and project tools 134. The project skill sets 132 are utilized to configure a first selector 108 for selecting at least one worker 136 for the project from the worker pool 114. The selected worker 138 is added to a working task queue 118. The worker pool 114 may comprise any combination of human talent, native (to the platform) digital workers, and third party digital workers from external trusted sources.

The system utilizes a selection algorithm 152 (described in more detail herein) to select digital workers for tasks and also to recommend digital workers for tasks. Digital works may be semi-developed (partially configured) for specific tasks with general capabilities in a particular field, and then trained over time to be efficient and accurate on specific species of tasks is that field.

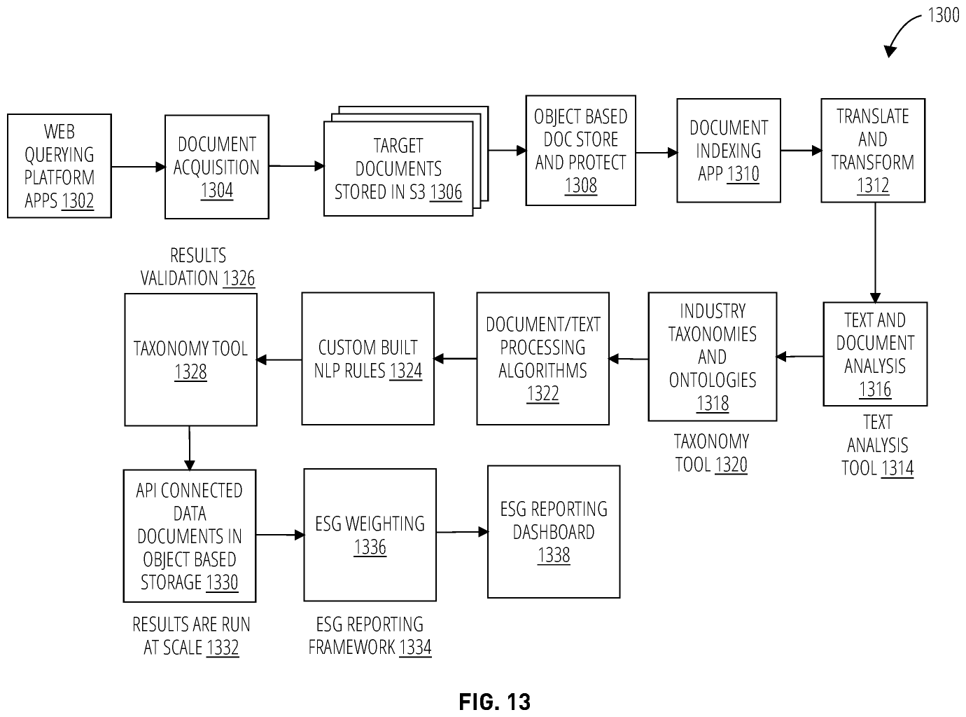

The selection algorithm 152 may utilize inputs in the form of a feature vector (see Table 1) such as width vs depth of skills needed for a task (full stack vs depth of specialization); a tolerance of a match of a digital worker to the skills needed for a task (closeness of fitness function); commitment to the task (full time vs part time); trainability of the digital worker; the task/project methodology e.g. Agile or other; and other constraints such as benchmarks, cost, and time to completion. In one embodiment the first selector 108 is one or more fully-connected deep network operable on feature vectors to generate classifiers in the range <1, 0>, and utilizing a fitness/error function for feedback and learning. In one embodiment the features set forth in Table 1 are weighted via a user interface (e.g., using sliders—see the machine user interface example depicted in FIG. 13) and the weight are applied to elements of the feature vector, changing its direction in a multi-dimensional space. Each digital worker comprises a feature vector pointing some direction in multi-dimensional space as well. Two vectors with a closest angular separation form a best fit between task requirements and digital worker. Training on the specific task to perform may then be applied to improve the fit especially on those features that contribute most to the angular separation. This approach is desirable for digital workers with a sufficient trainability metric.

The system may make recommendations to users for future tasks to use certain digital workers (or not) based on the features and weights they enter. Even if these digital workers don't initially comprises a best fit with the task requirements entered by a user, experience may teach the system that they are best suited for tasks comprising the feature/weight/constraint profile input by the user, for example after additional training is applied to the specific task at hand.

The project tools 134 are utilized to configure a second selector 110 for selecting an at least one container 140 from the container library 106. The configuration information for the selected at least one container 142 is communicated through the authorization service 144 and an API gateway 112 to allocate computing resources and generate the instance for the selected at least one container 142 creating the sandboxed environment 146. The selected worker 138 in the working task queue 118 is allowed access to the selected at least one container 142 in the sandboxed environment 146 through the authorization service 144 and by passing through the API gateway 112.

While executing the project, the selected worker 138 has access to automation and analysis tools 148 that provide the selected worker 138 with automated actions may include email notifications, alerts, automatically generated reports, risk calculations, confidence scores, extracting data/insights from documents, etc.

The monitoring service 150 monitors sandboxed environment digital worker resources and sandboxed environment computing resources. The monitoring service may comprise a digital worker activity tracker, a resource utilization tracker, and a project output evaluator. The monitoring service 134 communicates a payment release control to a payment service 142 in response to detecting the completion of the project.

In some configurations, the first selector 108 receives a ranked digital worker pool for the project by way of the rating engine 140. The rating engine 140 generates the ranked digital worker pool from task parameters 108 and the usage logs collected from the monitoring service 150.

In some configurations, the project skill sets 132 for digital workers may include development skill sets such as, but limited to, chatbots, data analytics, image pre-processing, text mining—sourcing, handwriting recognition, named entity recognition, optical character recognition, natural language processing, text summarization, machine translation, question answering, knowledge extraction, speech-to-text, sentiment analysis, etc.

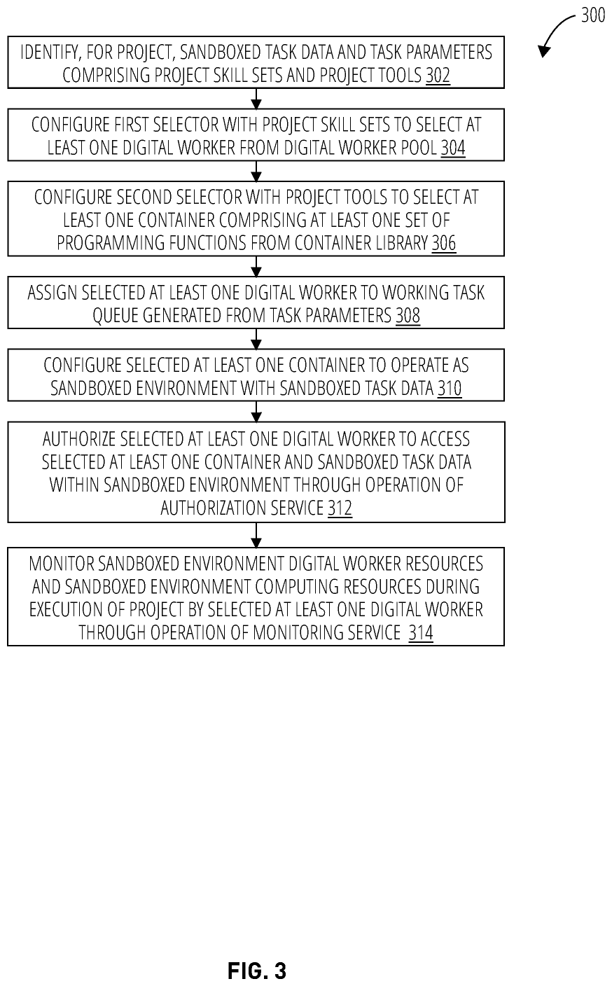

The system 100 may be operated in accordance with the process described in FIG. 3.

FIG. 3 depicts a method 300 for operating a resource configuration and project management system. In block 302, the method 300 identifies, for a project, sandboxed task data and task parameters comprising project skill sets and project tools. In block 304, the method 300 configures a first selector with the project skill sets to select at least one digital worker from a digital worker pool. In block 306, the method 300 configures a second selector with the project tools to select at least one container comprising at least one set of programming functions from a container library. In block 308, the method 300 assigns the selected at least one digital worker to a working task queue generated from the task parameters. In block 310, the method 300 configures the selected at least one container to operate as a sandboxed environment with the sandboxed task data. In block 312, the method 300 authorizes the selected at least one digital worker to access the selected at least one container and the sandboxed task data within the sandboxed environment through operation of an authorization service. In block 314, the method 300 monitors sandboxed environment digital worker resources and sandboxed environment computing resources during execution of the project by the selected at least one digital worker through operation of a monitoring service.

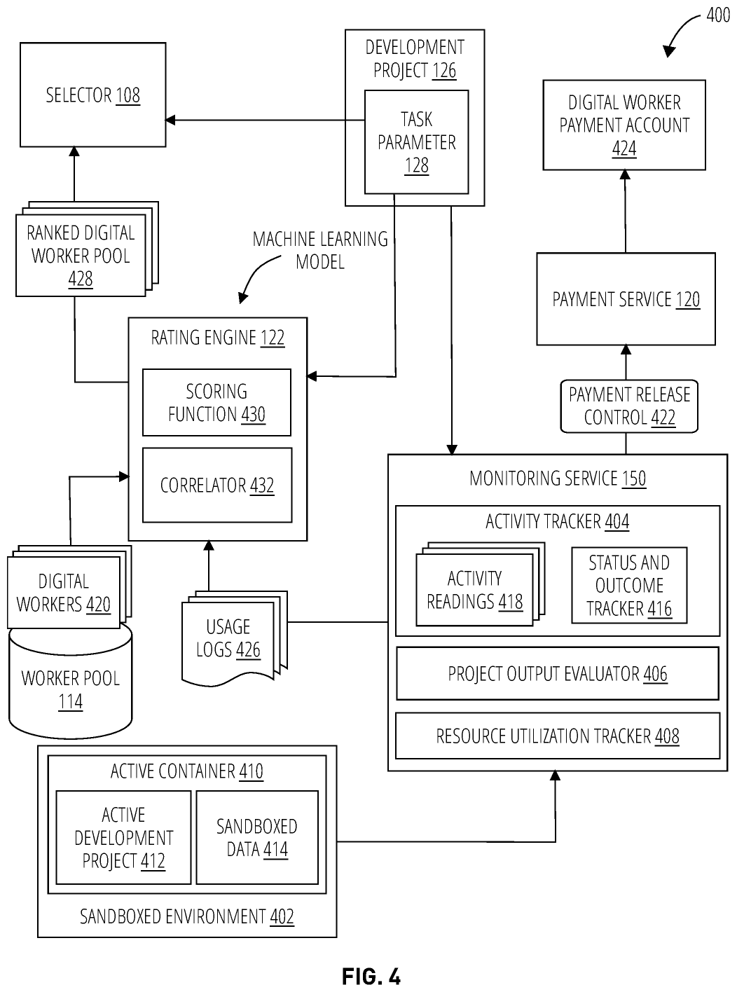

In FIG. 4, a system 400 for resource configuration and project management depicts operations of the monitoring service 150. The system 400 comprises a first selector 108, a rating engine 122, a payment service 120, a monitoring service 150, a worker pool 114, and a sandboxed environment 402. The monitoring service 150 comprises a digital worker activity tracker 404, a project output evaluator 406, and a resource utilization tracker 408. The monitoring service 150 monitors the sandboxed environment 402 comprising an active container 410 with an active development project 412 and the sandboxed data 414. The digital worker activity tracker 404 monitors sandboxed environment digital worker resources such as digital worker activity status (e.g., active, idle, processing, etc.,) through a status and outcome tracker 416 and periodically sample's the digital worker's activity and/or output (activity readings 418). The resource utilization tracker 408 monitors sandboxed environment computing resources, (e.g., memory, storage, processing resources, etc.). The resource utilization tracker 408 may be utilized to correlate computing resources utilized during a project to an expense report.

In some configurations, the digital worker activity tracker 404 may be a secure browser-based client based on a JIRA plugin that provides digital workers 420 the worker pool 114 or an organization's private TalentHub, to automatically upload project specific timesheets and worklogs. The digital worker activity tracker 404 provides the ability to access logs of task progress taken, for example, every 10 minutes.

The project output evaluator 406 receives an indication when a project or portion of a project is completed and may compare the completed project to the development project specification 126. In some configurations, the project output evaluator 406 may monitor the progress of the project and identify when the project or portion of a project is completed without receiving confirmation from a digital worker. When the project output evaluator 406 identifies the completion of the project or portion of the project, the monitoring service 150 releases a payment release control 422 to a payment service 120. The payment service 120 may be payment processing services that hold funds associated with a project and release the funds to the digital worker payment account 424 in response to the payment release control 422. The value of the funds may be configured by the development project specification 126 as well as any terms regarding partial completion of the project and payment schedules.

The monitoring service 150 generates usage logs 426 comprising the sandboxed environment digital worker resources and the sandboxed environment computing resources for a project. The usage logs 426 are communicated to the rating engine 122 to generate a ranked digital worker pool 428. The rating engine 122 comprises a scoring function 430 and correlator 432. The correlator 432 correlates the usage logs 426 to digital workers in the worker pool 114. The scoring function 430 generates a digital worker score from the usage logs 426 and the task parameter 128 for the project. In some configurations, the digital worker score identifies whether a particular digital worker is suited for a project based on their previous projects and the current task parameters for a new project in addition to the project skill sets sought for the project.

The scoring function 430 and correlator 432 may be implemented by a machine learning model such as a fully-connected deep neural network, that transforms task performance parameters into classifiers that may be compared with optimal performance metrics, and/or performance metrics for other digital workers. The implementation of such machine learning models will be apparent to those of ordinary skill in the art in view of this disclosure.

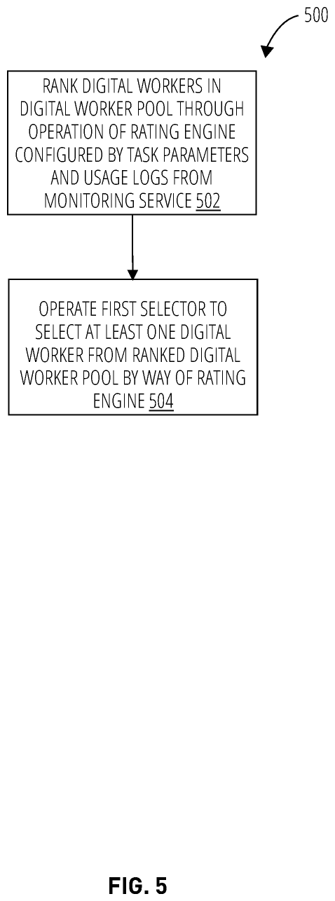

The system 400 may be operated in accordance with the process described in FIG. 3 and FIG. 5.

FIG. 5 depicts a method 500 for operating a resource configuration and project management system. In block 502, the method 500 ranks digital workers in the digital worker pool through operation of a rating engine configured by the task parameters and usage logs from the monitoring service. The usage logs comprise the sandboxed environment digital worker resources and the sandboxed environment computing resources collected by the monitoring service. In block 504, the method 500 operates the first selector to select the at least one digital worker from a ranked digital worker pool by way of the rating engine.

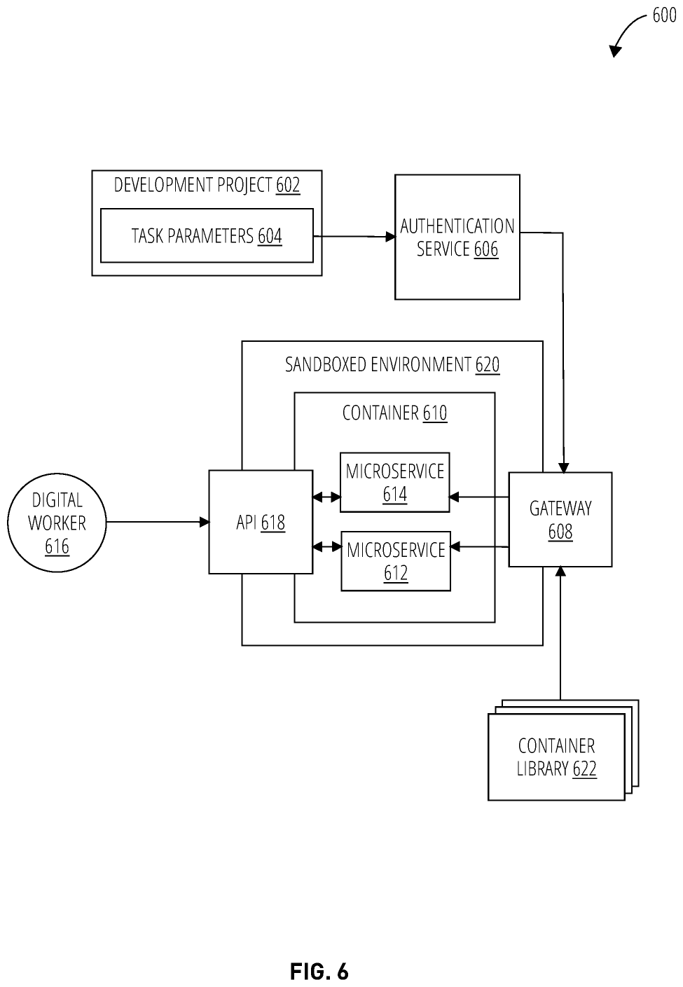

FIG. 6 depicts a system 600 in accordance with one embodiment. In the system 600, a development project specification 602 comprising task parameters 604 undergoes an authentication service 606 process before being communicated to a gateway 608. The gateway 608 may be configured with the task parameters 604 of the development project specification 602 to retrieve functions and/or microservices from a container 610. For example, the container 610 may include microservice 612 and microservice 614 that may be made available to a digital worker 616 to utilize through an application program interface API 618. The authentication service 606 may communicate information for allocating computing resources for the container 610 as a sandboxed environment 620.

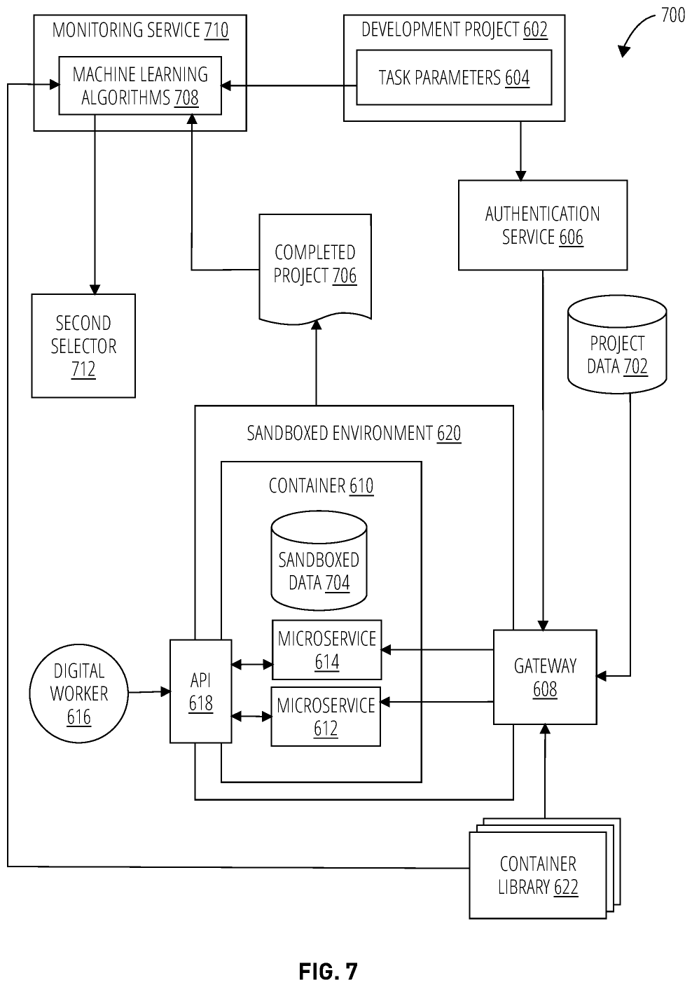

FIG. 7 depicts a system 700 in accordance with one embodiment. In the system 700, the development project specification 602 comprising task parameters 604 undergoes the authentication service 606 process before being communicated to the gateway 608. The gateway 608 may then be configured with the task parameters 604 of the development project specification 602 to retrieve microservice 612 and microservice 614 from the container 610. The task parameters 604 may also configure the gateway 608 to pull project data 702 to provide to the microservice 614 and microservice 612. The microservice 614 and the microservice 612 may be provided with sandboxed data 704 related to the development project specification 602. The operations of the microservice 612 and the microservice 614 within the container 610 operate in a sandboxed environment 620 accessible by the digital worker 616 through the API 618. A completed project 706 may be generated through the operation of the microservice 614 and the microservice 612.

The completed project 706 may be utilized by a machine learning algorithms 708 of a monitoring service 710. The machine learning algorithms 708 may generate container recommendations to configure the second selector 712 to select functional containers to be utilized by the project, wherein the machine learning algorithm utilizes the task parameters, previous completed projects, and usage logs to generate the container recommendations. In some configurations, the machine learning algorithms 708 may be utilized to reorganize containers in the container library 622 to improve the collection of functions and microservices associated with a particular set of requirements. For instance, depending on the completed project 706 for the task parameters 604 of the development project specification 602, the machine learning algorithms 708 may provide or modify the microservices in the container 610 provided to the digital worker 616 to complete their task in the future.

The machine learning algorithms 708 may incorporate aspects of a basic deep neural network 800 and artificial neuron 900 described below.

The machine learning algorithms 708 are trained (configured via training) to receive project data 702 and Q-score metrics for digital workers and/or human workers, and to classify workers in terms of suitability and match to context and requirements of a project, task, or sub-task of the project, and to match a preferred or optimal methodology. The methodology may also be selected from the project data 702 as a recommendations output of the machine learning algorithms 708. The matching may be a nearest match based on a configured tolerance or variance specified for an outcome in the project data 702.

The system then deploys those of the matched workers that are available with rules and instructions to execute against outcomes, specifications, and constraints in the project data 702. Progress and performance of the deployed workers and assessed as the work progresses on the project and at completion of the project. These assessments are applied as training data to improve the performance of the machine learning algorithms 708 classifications/matching for future projects.

Over time, the machine learning algorithms 708 learn the optimum mix of workers (digital and human) and their associated skill sets and other resources including compute, tools, and methodologies, to apply for a given type of project and outcomes. Outcomes may be defined as meeting either sub-project goals or an entire project goal. Outcomes are not be limited to technical specifications. Outcomes may include costs, efficiency, technology use (e.g., efficient deployment of open source code), optimized developer involvement, percent of component/code reuse, hardware platform optimization for efficiency or cost, etc.

The machine learning algorithms 708 may be utilized to ‘remix’ the worker set and/or resources or methodology for a project (or part of a project) in midstream of completion of the project or sub-part. This may be done for example if the initial worker set, methodology, and/or resources are providing insufficient to meet the project requirements.

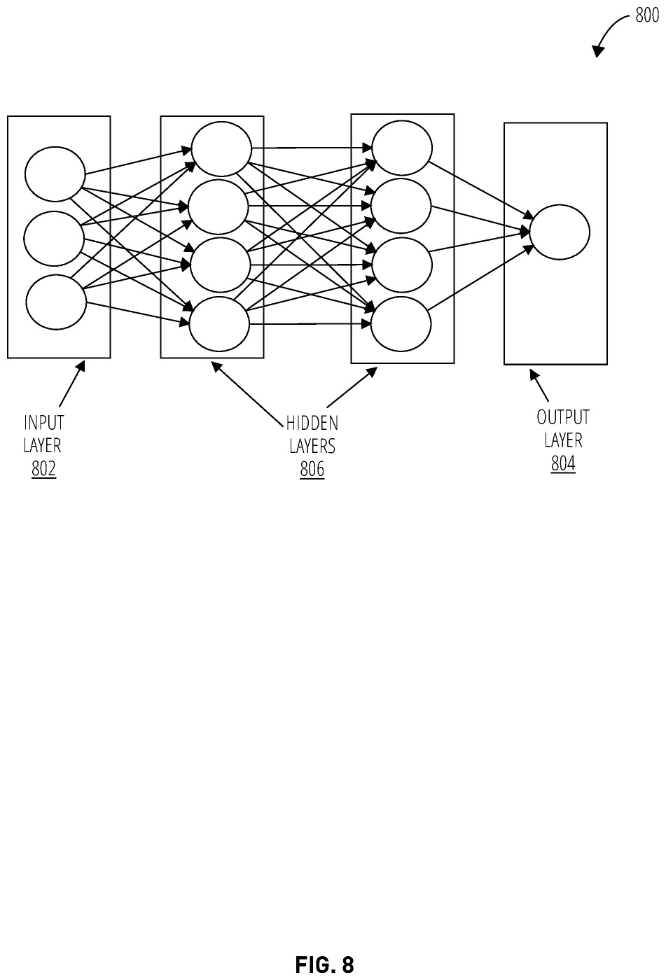

In FIG. 8, a basic deep neural network 800 is based on a collection of connected units or nodes called artificial neurons, which loosely model the neurons in a biological brain. Each connection, like the synapses in a biological brain, can transmit a signal from one artificial neuron to another. An artificial neuron that receives a signal can process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals travel from the first layer (the input layer 802), to the last layer (the output layer 804), possibly after traversing one or more intermediate layers, called hidden layers 806.

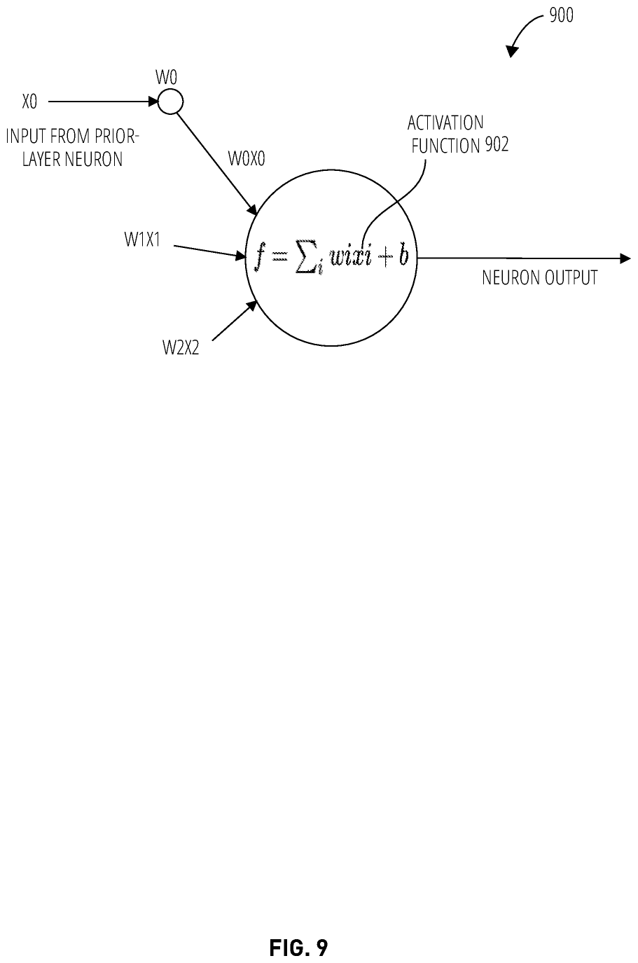

Referring to FIG. 9, an artificial neuron 900 receiving inputs from predecessor neurons consists of the following components:
inputs xᵢ;
weights wᵢ applied to the inputs;
an optional threshold (b), which stays fixed unless changed by a learning function; and
an activation function 902 that computes the output from the previous neuron inputs and threshold, if any.

An input neuron has no predecessor but serves as input interface for the whole network. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 902 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

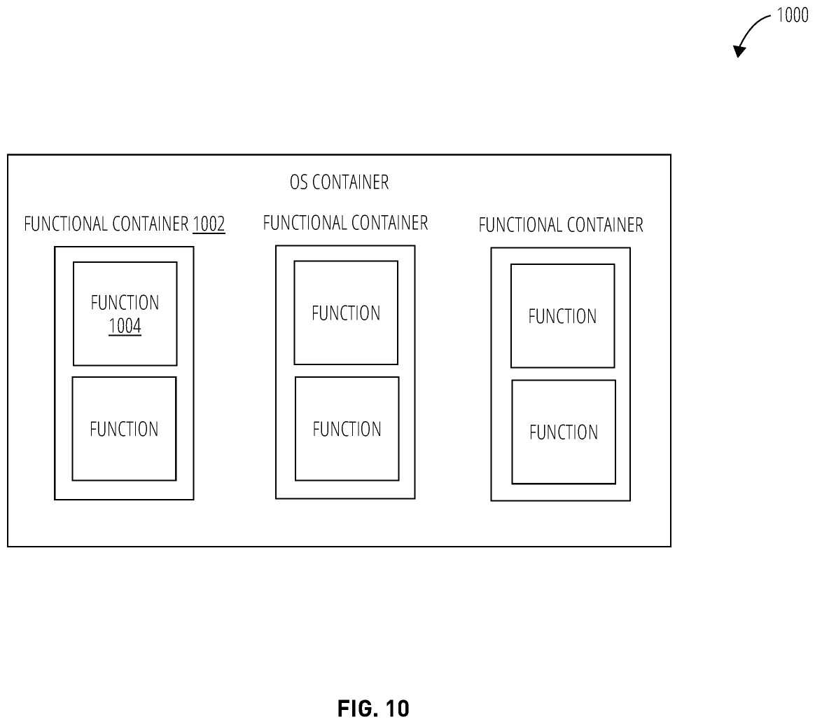

Referencing FIG. 10, an operating system OS container 1000 comprises an at least one functional container 1002 comprising at least one function 1004 (computing function/process/algorithm). The OS container 1000 may provide collection of related functional containers utilized in performing a specific task. The OS container 1000 provides the functional container 1002 as a collection of AI related functions, for example. The functional container 1002 serve as a collection of non-volatile resources used by computer programs, often for software development. These may include, but are not limited to, configuration data, documentation, help data, message templates, pre-written code and subroutines, classes, values or type specifications.

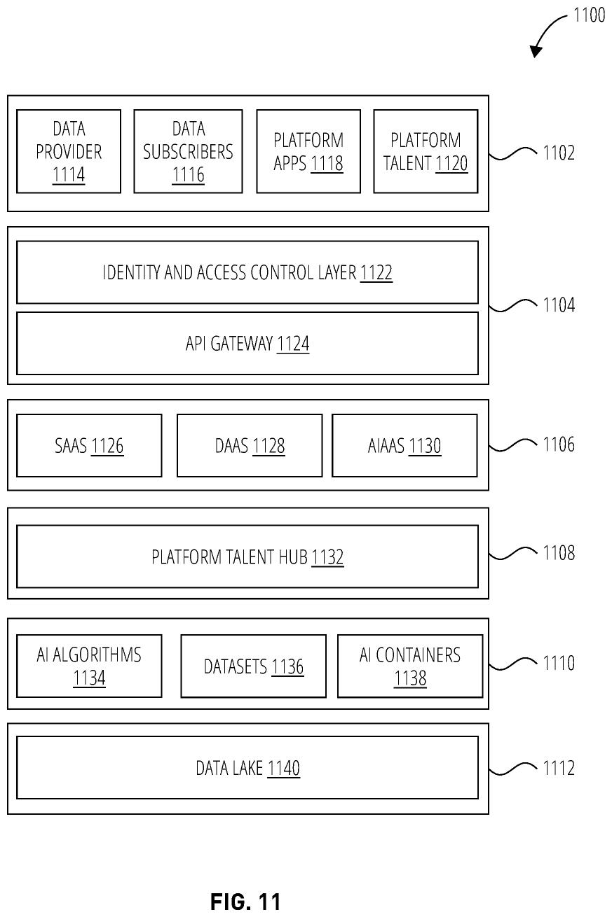

FIG. 11 depicts a high-level architecture 1100 of a platform operating the resource configuration and management system. The high-level architecture 1100 includes a front end 1102, transport access control 1104, services 1106, digital workers worker portal 1108, AI functions and data 1110, and storage 1112. The front end 1102 comprises data provider 1114, data subscribers 1116, platform software applications 1118, and platform talent 1120. The platform software applications 1118 comprise application interfaces for tools to perform tasks such as counter party risk assessment, ETF tracking, and bond analysis, as well as tools such as text analysis tool, taxonomy tool, project management tool, and ESG analysis, but is not limited thereto. The transport access control 1104 includes an identity and access control layer 1122 and an API gateway 1124. The identity and access control layer 1122 may offer access control functionality to services related to client access management and admin, monitoring, reporting, metering, billing, SSO, compliance, audit (auth0), etc. The API gateway 1124 may offer or provide robust and secure serverless framework that may include features for allowing REST API, Django functions, JSON web tokens (JWT). The services 1106 provide integration with software as a service 1126, data as a service 1128, and AI as a service 1130. In some configurations, the AI as a service 1130 may include work flow management, platform certified digital workers, time tracker & work diary services, cloud resource manager services (e.g., AWS), project management services (e.g., JIRA), code management services (e.g., Github), and collaboration services (e.g., Slack). The worker portal 1108 may include a platform talent hub 1132. The AI functions and data 1110 may include AI algorithms 1134, Datasets 1136, and AI containers 1138. The AI algorithms 1134 may include API accessible AI algorithms. The AI containers 1138 may include platform deep software—containers for performing functions such as source & collect, store & search, protect & encrypt, OCR, transform & translate, natural language processing, computer vision, analyze, and visualization. The storage 1112 may include data lake 1140 comprising, for example, billions of data points for training the AI algorithms.

FIG. 12 depicts a platform architecture 1200 of the resource configuration and management system. The platform architecture 1200 comprises a virtual private cloud 1202 monitored by a digital worker activity tracker 1204 and an annotation service 1206. The virtual private cloud 1202 comprises a platform front end 1208, an application load balancer 1210 that communicates to a client subdomain 1212, relational database services 1214, microservices 1216, a message broker 1218, a task processing service 1220 and a API interface for third party services 1222. The relational database services 1214 communicate with the microservices 1216 and the task processing service 1220. the microservices 1216 communicates with the message broker 1218 and the relational database services 1214. The task processing service 1220 communicates with the message broker 1218 and the relational database services 1214. The third party services 1222 communicates with the platform front end 1208. The platform front end 1208 communicates with the third party services 1222, the relational database services 1214, the microservices 1216, and the task processing service 1220. The platform front end 1208 communicates with the client subdomain 1212 through the application load balancer 1210.

The virtual private cloud 1202 also includes an SSL certificate 1224. The relational database services 1214 comprise data utilized by the microservices 1216. The microservices 1216 include an authorization service 1226, projects service 1228, subscription service 1230, a computing resources service 1232, a digital worker pool service 1234, a data exchange service 1236, and an API gateway 1238. The relational database services 1214 comprise relation databases for an authorization service 1240, project service 1242, computing resources service 1244, subscription service 1246, digital worker pool service 1248, API gateway 1250, and data exchange service 1252. The microservices 1216 may have access to automation and analysis tools such as Bots+algorithms 1254, AI applications 1256, and starter kits 1258. The Bots+algorithms 1254 may include document intelligence, Natural Language Processing (NLP), Computer Vision algorithms, and Custom Industry Specific Bots (e.g., scrapers, web crawler, etc.). The AI applications 1256 may include preconfigured applications for natural language processing, computer vision, and sourcing and data collecting (i.e., scrapping). The starter kits 1258 may include preconfigured applications and manuals for data science, machine learning, deep learning, and sourcing and data collection (scrapping).

The data exchange service 1236 may be operated as a whole, or as a standalone microservice that provides users the ability to programmatically search, access, subscribe to, and link core, alternative or training datasets. Each standalone service may require an application for managing the users in an organization, such as Q-Auth.

The subscription service 1230 may be operated to create, manage, update and automatically publish subscription-based datasets that can be linked via API to systems, applications or AI development projects. The subscription service 1230 may allow for the management of user subscriptions, set and track API calls, and with an integrated Payment Gateway quickly create, publish and monetize data assets.

In some configurations, the platform front end 1208 may run instances of Ubuntu OS, Angular, NodeJS (Web Server—Nginx) on t3.medium with 2 vCPUs, 4GB of Memory, 150GB Storage.

In some configurations, the microservices 1216 may operate as the backend for the platform. The backend of the platform may run instances of API gateway Service Instance, Ubuntu OS, Django (Web Server—Nginx) on m5.xlarge with 4 vCPUs, 8GB of Memory, 150GB Storage.

In some configurations, the virtual private cloud 1202 may run background instances of Ubuntu OS, Django, Celery, SendGrid, Sentry (Web Server—Nginx) on m5.xlarge with 4 vCPUs, 8GB of Memory, 150GB Storage.

In some configurations, the relational database services 1214 may operate on db.t3.medium with 2 vCPUs, 4GB of Memory, 30GB Storage Single RDS instance running PostgreSQL with seven databases: authorization service, computing resources service, data exchange service, API gateway project services, subscription services, and digital worker pool services.

In some configurations, the third party services 1222 may include, but are not limited to, AWS (computer resources), Jira (project management, Slack (group communications), Github (source code management), Sendgrid (email messaging), Stripe (payments gateway).

In some configurations, the message broker 1218 may be a ElastiCache-Redis Service operating on cache.m4.large, vCPU: 2, Memory: 6.42GB.

FIG. 13 depicts a workflow 1300 in accordance with one embodiment. The workflow 1300 may involve web querying platform software applications (block 1302). In block 1304, the workflow 1300 involves document acquisition. Once block 1304 completes, the documents are targeted for storage in object storage in a web service interface (e.g., Amazon Web Services Simple Storage Service—AWS S3) (block 1306). Following block 1306, the object based storage stores and protects the documents (block 1308). The stored documents are then transferred to a document indexing app in block 1310. In block 1312, the document indexing app translates and transforms the document content. Examples of transformation include, the transformation of a PDF document to machine readable text, formatted content. Additionally, the translation of multiple languages to a selected single language may be performed. The translated and transformed document content is then sent to a text analysis tool 1314 that performs text and document analysis in block 1316. In block 1318, a taxonomy tool 1320 identifies industry taxonomies and ontologies. In block 1322, the output of the taxonomy tool 1320 may be handed off to document/text processing algorithms. In block 1324, the output from block 1322 goes through NLP rules, built using machine and deep learning based methods. The output from block 1324 may then undergo results validation 1326 using taxonomy tool in block 1328. The output of block 1328 may be utilized by API connected data documents in object based storage in block 1330 where the results are run at scale 1332. The output of block 1330 is then handed off to the ESG reporting framework 1334 the performs ESG weighting in block 1336. The output from block 1336 is then handed off to the ESG reporting dashboard in block 1338.

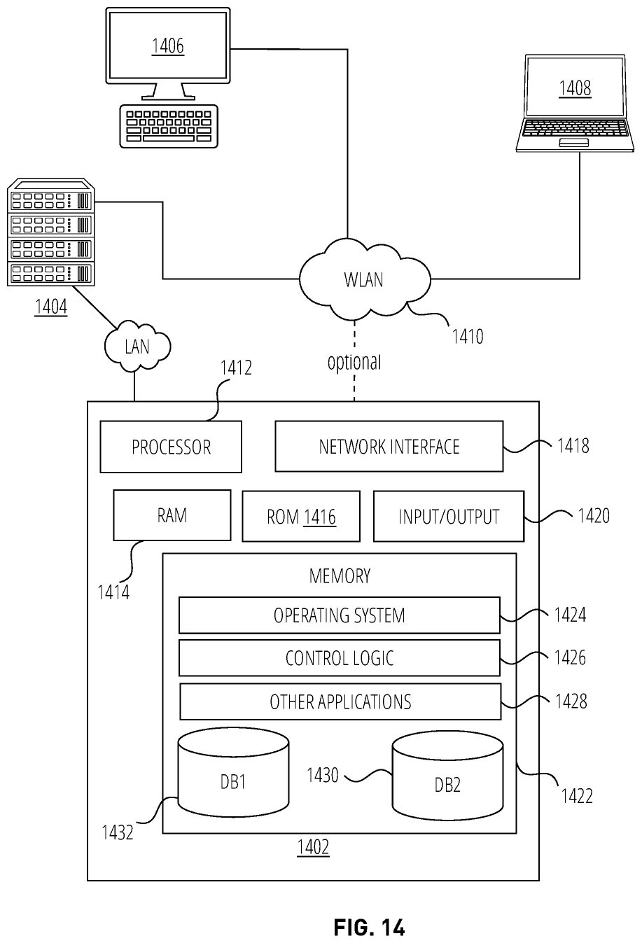

FIG. 14 depicts one example of a system architecture and data processing device that may be used to implement one or more illustrative aspects described herein in a standalone and/or networked environment. Various network nodes data server 1402, web server 1404, computer 1406 (i.e., computing apparatus), and laptop 1408 may be interconnected via a wide area network 1410 (WAN), such as the internet. Other networks may also or alternatively be used, including private intranets, corporate networks, LANs, metropolitan area networks (MANs) wireless networks, personal networks (PANs), and the like. Network 1410 is for illustration purposes and may be replaced with fewer or additional computer networks. A local area network (LAN) may have one or more of any known LAN topology and may use one or more of a variety of different protocols, such as ethernet. Devices data server 1402, web server 1404, computer 1406, laptop 1408 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data--attributable to a single entity--which resides across all physical networks.

The components may include data server 1402, web server 1404, and client computer 1406, laptop 1408. Data server 1402 provides overall access, control and administration of databases and control software for performing one or more illustrative aspects described herein. Data server data server 1402 may be connected to web server 1404 through which users interact with and obtain data as requested. Alternatively, data server 1402 may act as a web server itself and be directly connected to the internet. Data server 1402 may be connected to web server 1404 through the network 1410 (e.g., the internet), via direct or indirect connection, or via some other network. Users may interact with the data server 1402 using remote computer 1406, laptop 1408, e.g., using a web browser to connect to the data server 1402 via one or more externally exposed web sites hosted by web server 1404. Client computer 1406, laptop 1408 may be used in concert with data server 1402 to access data stored therein, or may be used for other purposes. For example, from client computer 1406, a user may access web server 1404 using an internet browser, as is known in the art, or by executing a software application that communicates with web server 1404 and/or data server 1402 over a computer network (such as the internet).

Servers and applications may be combined on the same physical machines, and retain separate virtual or logical addresses, or may reside on separate physical machines. FIG. 14 depicts just one example of a network architecture that may be used, and those of skill in the art will appreciate that the specific network architecture and data processing devices used may vary, and are secondary to the functionality that they provide, as further described herein. For example, services provided by web server 1404 and data server 1402 may be combined on a single server.

Each component data server 1402, web server 1404, computer 1406, laptop 1408 may be any type of known computer, server, or data processing device. Data server 1402, e.g., may include a processor 1412 controlling overall operation of the data server 1402. Data server 1402 may further include RAM 1414, ROM 1416, network interface 1418, input/output interfaces 1420 (e.g., keyboard, mouse, display, printer, etc.), and memory 1422. Input/output interfaces 1420 may include a variety of interface units and drives for reading, writing, displaying, and/or printing data or files. Memory 1422 may further store operating system software 1424 for controlling overall operation of the data server 1402, control logic 1426 for instructing data server 1402 to perform aspects described herein, and other application software 1428 providing secondary, support, and/or other functionality which may or may not be used in conjunction with aspects described herein. The control logic may also be referred to herein as the data server software control logic 1426. Functionality of the data server software may refer to operations or decisions made automatically based on rules coded into the control logic, made manually by a user providing input into the system, and/or a combination of automatic processing based on user input (e.g., queries, data updates, etc.).

Memory 1422 may also store data used in performance of one or more aspects described herein, including a first database 1430 and a second database 1432. In some embodiments, the first database may include the second database (e.g., as a separate table, report, etc.). That is, the information can be stored in a single database, or separated into different logical, virtual, or physical databases, depending on system design. Web server 1404, computer 1406, laptop 1408 may have similar or different architecture as described with respect to data server 1402. Those of skill in the art will appreciate that the functionality of data server 1402 (or web server 1404, computer 1406, laptop 1408) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

### LISTING OF DRAWING ELEMENTS

100 system

102 user interface

104 parser

106 container library

108 first selector

110 second selector

112 API gateway

114 worker pool

116 digital workers

118 working task queue

120 payment service

122 rating engine

124 authorization service

126 development project specification

128 task parameter

130 sandboxed task data

132 project skill sets

134 project tools

136 worker

138 selected worker

140 at least one container

142 selected at least one container

144 authorization service

146 sandboxed environment

148 automation and analysis tools

150 monitoring service

152 selection algorithm

300 method

302 block

304 block

306 block

308 block

310 block

312 block

314 block

400 system

402 sandboxed environment

404 digital worker activity tracker

406 project output evaluator

408 resource utilization tracker

410 active container

412 active development project

414 sandboxed data

416 status and outcome tracker

418 activity readings

420 digital workers

422 payment release control

424 digital worker payment account

426 usage logs

428 ranked digital worker pool

430 scoring function

432 correlator

500 method

502 block

504 block

600 system

602 development project specification

604 task parameters

606 authentication service

608 gateway

610 container

612 microservice

614 microservice

616 digital worker

618 API

620 sandboxed environment

622 container library

700 system

702 project data

704 sandboxed data

706 completed project

708 machine learning algorithms

710 monitoring service

712 second selector

800 basic deep neural network

802 input layer

804 output layer

806 hidden layers

900 artificial neuron

902 activation function

1000 OS container

1002 functional container

1004 at least one function

1100 high-level architecture

1102 front end

1104 transport access control

1106 services

1108 worker portal

1110 AI functions and data

1112 storage

1114 data provider

1116 data subscribers

1118 platform software applications

1120 platform talent

1122 identity and access control layer

1124 API gateway

1126 software as a service

1128 data as a service

1130 AI as a service

1132 platform talent hub

1134 AI algorithms

1136 Datasets

1138 AI containers

1140 data lake

1200 platform architecture

1202 virtual private cloud

1204 activity tracker

1206 annotation service

1208 platform front end

1210 application load balancer

1212 client subdomain

1214 relational database services

1216 microservices

1218 message broker

1220 task processing service

1222 third party services

1224 SSL certificate

1226 authorization service

1228 projects service

1230 subscription service

1232 computing resources service

1234 digital worker pool service

1236 data exchange service

1238 API gateway

1240 authorization service

1242 project service

1244 computing resources service

1246 subscription service

1248 digital worker pool service

1250 API gateway

1252 data exchange service

1254 Bots+algorithms

1256 AI applications

1258 starter kits

1300 workflow

1302 block

1304 block

1306 block

1308 block

1310 block

1312 block

1314 text analysis tool

1316 block

1318 block

1320 taxonomy tool

1322 block

1324 block

1326 results validation

1328 block

1330 block

1332 results are run at scale

1334 ESG reporting framework

1336 block

1338 block

1402 data server

1404 web server

1406 computer

1408 laptop

1410 network

1412 processor

1414 RAM

1416 ROM

1418 network interface

1420 input/output interfaces

1422 memory

1424 operating system software

1426 control logic

1428 other application software

1430 first database

1432 second database

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.0 § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

What is claimed is:

1. A software-as-a-service system comprising:
at least one processor; and
a memory storing instructions that, when executed by the at least one processor, configure the system to:
receive from a user a set of weighted requirements for a task;
apply the weighted task requirements to a machine learning model to generate one or more classifiers relating the task requirements to capabilities of digital workers in a digital worker pool;
select one or more of the digital workers based on the weighted requirements;
execute the selected digital workers to perform the task;
evaluate a performance of the selected digital workers on the requirements for the task; and
input the weighted task requirements and results of the evaluation to an error function to generate a feedback signal to adapt the machine learning model.

2. The system of claim 1, wherein the feedback signal is unsupervised.

3. The system of claim 1, wherein the instructions, when executed by the at least one processor, further configure the system to:
assign the selected digital workers to a task queue generated from the weighted requirements.

4. The system of claim 1, wherein the instructions, when executed by the at least one processor, further configure the system to:
authorize the selected digital workers to operate with sandboxed settings for the task.

5. The system of claim 1, wherein the instructions, when executed by the at least one processor, further configure the system to:
rank digital workers in the digital worker pool based on the weighted requirements and usage logs resulting from execution of the selected digital workers to perform the task.

6. The system of claim 5, wherein the instructions, when executed by the at least one processor, further configure the system to:
form collaborative clusters of the digital workers based on the rankings.

7. The system of claim 1, wherein the task is a digital document processing task.

8. A computing apparatus comprising:
at least one processor; and
a memory storing instructions that, when executed by the at least one processor, configure the system to:
identify, for a project, sandboxed task data and task parameters comprising project skill sets and project tools;
configure a first selector comprising a machine learning model with the project skill sets to select at least one digital worker from a digital worker pool;
configure a second selector with the project tools to select at least one container comprising at least one set of programming functions from a container library;
assign the selected at least one digital worker to a working task queue generated from the task parameters;
configure the selected at least one container to operate as a sandboxed environment with the sandboxed task data;
authorize the selected at least one digital worker to access the selected at least one container and the sandboxed task data within the sandboxed environment through operation of an authorization service;
monitor sandboxed environment digital worker resources and sandboxed environment computing resources during execution of the project by the selected at least one digital worker through operation of a monitoring service; and
wherein feedback from the monitoring service is applied to adapt a configuration of the first selector.

9. The computing apparatus of claim 8, wherein the instructions further configuring the apparatus to:
rank digital workers in the digital worker pool based on the task parameters and usage logs from the monitoring service, wherein the usage logs comprise the sandboxed environment digital worker resources and the sandboxed environment computing resources collected by the monitoring service; and
operate the first selector to select the at least one digital worker from a ranked digital worker pool by way of the rating engine.

10. The computing apparatus of claim 9, wherein the instructions further configuring the apparatus to:
form collaborative clusters of the digital workers based on the rankings.

11. The computing apparatus of claim 8, wherein the first selector operates on a feature vector for the project skill set comprising elements for Productivity, Accuracy, Consistency, Reliability, Compliance, Trainability, Learnability, Scalability, and Compatibility.

12. A method for forming collaborative clusters of digital workers in a digital worker pool, the method comprising:
receiving from a user a set of weighted requirements for a digital document processing task;
applying the weighted task requirements to a machine learning model to generate one or more classifiers relating the task requirements to capabilities of the digital workers;
selecting one or more of the digital workers based on the weighted requirements;
executing the selected digital workers to perform the task;
evaluating a performance of the selected digital workers on the requirements for the task;
applying the weighted task requirements and results of the evaluation to generate an unsupervised feedback signal to adapt the machine learning model;
ranking digital workers in the digital worker pool based on the weighted requirements and results of executing the selected digital workers to perform the task; and
forming the collaborative clusters of the digital workers based on the rankings.

13. The method of claim 12, further comprising:
assigning the selected digital workers to a task queue generated from the weighted requirements.

14. The method of claim 12, further comprising:
authorizing the selected digital workers to operate with sandboxed data for the task.

15. The method of claim 12, wherein the weighted task requirements comprise a tensor with elements for Productivity, Accuracy, Consistency, Reliability, Compliance, Trainability, Learnability, Scalability, and Compatibility.
